(19) United States
(12) Patent Application Publication
(10) Pub. No.: US 2026/0358470 A1
(43) Pub. Date: Nov. 12, 2026

(54) PHASED ARRAY ANTENNA BEAMFORMING PERFORMANCE TESTING

(71) Applicant: Hughes Network Systems, LLC, Germantown, MD (US)

(72) Inventors: Mu Li, Germantown, MD (US); Channasandra S. Ravishankar, Clarksburg, MD (US); Kumud Patel, Clarksburg, MD (US); John E. Corrigan, III, Miami Beach, FL (US)

(21) Appl. No.: 19/279,345

(22) Filed: Jul. 24, 2025

Related U.S. Application Data
(60) Provisional application No. 63/798,930, filed on May 2, 2025.

(51) Int. Cl. G01S 7/40; H01Q 3/26

(52) U.S. Cl. CPC G01S 7/4008; H01Q 3/267

(57) ABSTRACT

A method of calibrating a phased antenna of a communication device includes providing a test antenna and a computer system and positioning the phased array antenna such that a distance between the phased array antenna and the test antenna is less than a far-field distance for a selected transmission frequency. The computer system performs operations including causing an antenna element of the phased array antenna to make a transmission on an over-air radio link to the test antenna and, at the test antenna, measuring a radiofrequency (RF) signal resulting from the transmission. Operations further include generating a performance measure for the antenna element based on the RF signal at the test antenna, calculating an adjusted performance measure including a correction to approximate performance of the antenna element in a far-field, and storing the correction as calibration data for the antenna element.

### CROSS-REFERENCE TO RELATED APPLICATIONS

The present application claims the benefit of U.S. Provisional Patent Application No. 63/798,930, filed May 2, 2025, and titled “Phased Array Antenna Beamforming Performance Testing,” which application is incorporated herein in its entirety by reference.

### BACKGROUND

The present specification relates to techniques for testing and calibration of beamforming antennas.

Phased array antennas include multiple antenna elements that can be excited in different ways to change the shape and direction of the radiation pattern from the antenna. By changing the phase and amplitude of signals provided to the various antenna elements, beams can be steered to different spatial positions without physically moving the antenna.

### SUMMARY

In some implementations, a system is configured to characterize the performance of phased array antennas using a compact test range that tests antenna performance at a distance much shorter than the typical far field distance. The signals measured in the compact test range are different from those that would be received in far field range, so the system performs processing to compensate for the differences.

In embodiments, a method of calibrating a phased array antenna of a communication device, wherein the phased array antenna including a plurality of antenna elements, is disclosed. The method includes providing a test antenna and a computer system, the computer system being configured for controlling operations of the phased array antenna and the test antenna, and positioning the phased array antenna with respect to the test antenna such that a distance between the phased array antenna and the test antenna is less than a far-field distance for a selected transmission frequency. The computer system includes one or more processors and memory storing computer-executable instructions that, when executed by the one or more processors, perform operations including causing a first one of the plurality of antenna elements of the phased array antenna to make a transmission on an over-air radio link between the phased array antenna and the test antenna, and at the test antenna, measuring a radiofrequency (RF) signal resulting from the transmission. The operations further includes generating a performance measure for the first one of the plurality of antenna elements of the phased array antenna based on the RF signal so measured at the test antenna, and calculating an adjusted performance measure including a correction to approximate performance of the first one of the plurality of antenna elements of the phased array antenna in a far-field. The operations further includes storing the correction as calibration data for the first one of the plurality of antenna elements of the phased array antenna.

In embodiments, the performance measure includes at least one of equivalent isotropic radiated power of the phased array antenna and a gain-to-noise temperature of an antenna element of the phased array antenna. In embodiments, the distance between the phased array antenna and the test antenna is from ½ of the far field distance to 1/20 of the far field distance or from ⅕ of the far field distance to 1/15 of the far field distance. In certain embodiments, the method includes repeating the operations for multiple frequencies over a selected frequency range.

In embodiments, the method further includes repeating the operations for a second one of the plurality of antenna elements of the phased array antenna. In certain embodiments, the method further includes obtaining the calibration data for all of the plurality of antenna elements of the phased array antenna. In certain embodiments, the method further includes providing the calibration data to the communication system to enable adjustment of signals provided to the phased array antenna based on the calibration data.

In embodiments, the method further includes evaluating beamforming performance of the phased array antenna for transmission. In certain embodiments, evaluating includes determining a set of beam positions to test and, for each selected beam position in the set of beam positions, causing the plurality of antenna elements of the phased array antenna to transmit at the selected beam position, measuring a power level for signals received at the test antenna as a result of the plurality of antenna elements of the phased array antenna transmitting at the selected beam position, calculating a differential power level based on the power level so measured and a known value of measured power at the test antenna for transmission from a boresight beam, calculating an adjusted differential power level by applying an adjustment based on the distance between the phased array antenna and the test antenna and comparing the differential power level for the selected beam position with the adjusted differential power level for the selected beam position.

In embodiments, the method further includes evaluating beamforming performance of the phased array antenna for reception. The evaluating includes determining a set of beam positions to test and, for each selected beam position in the set of beam positions, configuring antenna elements of the phased array antenna for reception at the selected beam position, causing the test antenna to provide a test transmission toward the phased array antenna, calculating a differential power level based on the power level so measured and a known value of measured power received at the phased array antenna from a boresight beam, calculating an adjusted differential power level by applying an adjustment based on the distance between the phased array antenna and the test antenna, and comparing the differential power level for the beam position with the adjusted differential power for the beam position.

In an alternative embodiment, a system for calibrating a phased array antenna is disclosed. The system includes a test antenna, a first radiofrequency (RF) measurement instrument configured to deliver signals for the test antenna to transmit and measure characteristics of signals received by the test antenna, a second RF measurement instrument configured to deliver signals for the phased array antenna to transmit and measure characteristics of signals received by the phased array antenna, and a computer system including one or more processors and memory storing computer-executable instructions that, when executed by the one or more processors, perform operations. The operations include determining performance characteristics of the phased array antenna based on interactions between the test antenna and the phased array antenna on an over-air radio link at a selected frequency while the phased array antenna is positioned with respect to the test antenna such that a distance between the phased array antenna and the test antenna is less than a far-field distance for the selected transmission frequency. The operations further include calculating a performance measure indicative of far field performance of the phased array antenna based on measurements of interactions between the test antenna and the phased array antenna on the over-air radio link.

In certain embodiments, the system further includes an enclosure for supporting the test antenna and the phased array antenna therein, wherein an internal surface of the enclosure includes material configured to dampen RF waves incident thereon.

In certain embodiments, the operations further include controlling the second radiofrequency measurement instrument to cause the phased array antenna to make a transmission to the test antenna on the over-air radio link, controlling the first radiofrequency measurement instrument to measure power received at the test antenna as a result of the transmission from the phased array antenna, calculating a measure of equivalent isotropic radiated power (EIRP) for the phased array antenna based on the measured power received at the test antenna, generating an adjusted EIRP that is indicative of far-field EIRP for the phased array antenna, incorporating the adjusted EIRP into the performance measure, and generating calibration data based on the performance measure.

In certain embodiments, the phased array antenna is integrated into a communication system, and the operations further include providing the calibration data to the communication system for use in adjusting signals provided to the phased array antenna based on the calibration data.

In certain embodiments, the performance measure includes at least one of equivalent isotropic radiated power (EIRP) and a gain-to-noise-temperature (G/T) of the phased array antenna.

In certain embodiments, the operations further include controlling the first radiofrequency measurement instrument to cause the test antenna to make a transmission to the phased array antenna on the over-air radio link, controlling the second radiofrequency measurement instruments to measure a signal-to-noise ratio (SNR) for the phased array antenna as a result of the transmission from the test antenna, and calculating a measure of gain-to-noise-temperature (G/T) based on the measured SNR for the phased array antenna, generating an adjusted G/T that is indicative of far-field G/T for the phased array antenna, and incorporating the adjusted G/T into the performance measure.

In certain embodiments, the computer system is configured to test performance of the phased array antenna for multiple frequencies over a selected frequency range.

In certain embodiments, the computer system is configured to evaluate beamforming performance of the phased array antenna for each of multiple beam positions based on interactions on the over-air radio link.

In another embodiment, we disclose a non-transitory computer-readable media storing computer-executable instructions that, when executed by one or more processors of a computing system, to cause the one or more processors to perform operations. The operations include causing at least one of a phased array antenna and a test antenna to make a transmission on an over-air radio link between the phased array antenna and the test antenna while the phased array antenna and the test antenna are located within a compact testing range such that the transmission is measurable at at least one of the phased array antenna and the test antenna. The operations further include generating a performance measure for the phased array antenna based on the RF signal so measured at at least one of the phased array antenna and the test antenna, calculating an adjusted performance measure including a correction to approximate performance of the phased array antenna in a far-field, and storing the correction as calibration data for the phased array antenna. The phased array antenna is located at a distance to the test antenna that is less than a far-field distance for a frequency of the transmission.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for phased array antenna beam forming performance testing.

FIG. 2 is a diagram illustrating planar wavefronts and spherical wavefronts incident to antenna arrays.

FIG. 3 is a diagram illustrating beam pointing directions of a phased array antenna.

FIG. 4 is a flow diagram illustrating an example of a process for calibrating antenna array elements.

FIG. 5 is a flow diagram illustrating an example of a process for calculating EIRP of a phased array antenna using a compact test range and storing calibration data of a communication device.

FIG. 6 is a flow diagram illustrating an example of a process for calculating G/T using a compact test range and storing calibration data of a communication device.

FIGS. 7A-7B are flow diagrams illustrating examples of processes for beamforming pattern verification using a compact test range and storing calibration data of a communication device.

Like reference numbers and designations in the various drawings indicate like elements.

### DETAILED DESCRIPTION

There has been a tremendous growth in demand for phased array antenna technology, stimulated partly by recent development in Low Earth Orbit (LEO) constellation systems, where a user terminal consistently tracks the movement of satellites to maintain a radio link. Compared with traditional mechanical tracking antennas, phased array antennas can steer the beams much more rapidly and without using any moving parts, which allows phased array antennas to provide superior performance and reliability.

During factory production of phased array antennas, each unit typically needs to be individually tested and characterized to ensure its quality and to measure the RF parameters required during operation. To achieve improved throughput in factory production of phased array antennas, it is desirable for the test methodology to be rigorous yet efficient to meet quantity and yield requirements during mass production.

When a phased array antenna is at a relatively close distance from a signal source, the measured signals incident at the phased array antenna are effectively spherical waves rather than planar waves, and so measures of equivalent isotropic radiated power (EIRP), gain over system noise temperature (G/T), and beam shape are different from the far field performance that is expected in normal use. In far-field conditions, the incident waves are essentially planar, so the wavefront reaches the array elements at essentially the same time. By contrast, when a phased array antenna receiving a spherical wave, the amplitude and phase received by each array element differs due to the spherical shape of propagation.

To compensate for the differences between near-field measurements and desired far-field characteristics, the system can compute and apply correction factors based on the difference in phased array directivity between compact range distance used and the far field distance. These corrections vary based on frequency, and so the corrections are also adjusted based on the transmission frequency used. With these techniques, measurements made in a compact test range can be adjusted or compensated to obtain corresponding far-field EIRP values and other far-field performance measures. With this information, the system can generate and store calibration data in a tested communication device, such as a satellite terminal, so that device operation is calibrated for the performance characteristics of the antenna when in typical far-field conditions, even though testing occurred in near-field conditions in the compact test range.

The equivalent isotropic radiated power (EIRP) of an antenna is an important factor in understanding an antenna's behavior and in operating the antenna. For example, the EIRP value is often used to determine how much power should be applied in order to achieve a desired level of output radiated power in a transmission. For satellite communications, an accurate measure of the EIRP of an antenna is important for a satellite terminal to perform efficient and reliable communication. Many satellite terminals include settings or calibration values that are based on the EIRP of the antenna, and efficiency decreases if those values are incorrect. For example, if the EIRP of the antenna is actually higher than expected, the satellite terminal may expend more power in making transmissions than is needed, resulting in lower power efficiency, and may be operated with a throughput that is lower than the transmitter could actually support. On the other hand, if the EIRP of the antenna is lower than expected, the satellite terminal's transmissions may be weaker than expected, which may lead to the need for retransmissions and inefficient use of limited spectrum resources.

Other antenna performance characteristics, such as gain for reception (e.g., G/T) and the performance with respect to different beam shapes or beam orientations, are also important in calibrating communication devices for efficient communication.

Testing and calibration of phased array antenna beam forming performance test typically involves calibration of the antenna elements and measurements of EIRP, G/T, and beamforming radiation patterns. These measurements are then used to store calibration data for operating parameters for a communication device, such as a very small aperture terminal (VSAT), that uses the phased array antenna. Traditionally, these performance metrics are characterized in a far-field test range, with assistance from a mechanical positioner that can move components relative to each other. However, this test approach is often not suitable for mass production in a factory setting, where it is desirable for accurate testing to be performed in time efficient and space-efficient manner. In addition, it is not always practical to construct a true far field test range in a factory environment.

The techniques discussed herein allow testing and calibration using a simple and low-cost compact test range, using algorithms to characterize the phased array beamforming performance accurately and efficiently, making it particularly suitable for applications in mass production settings.

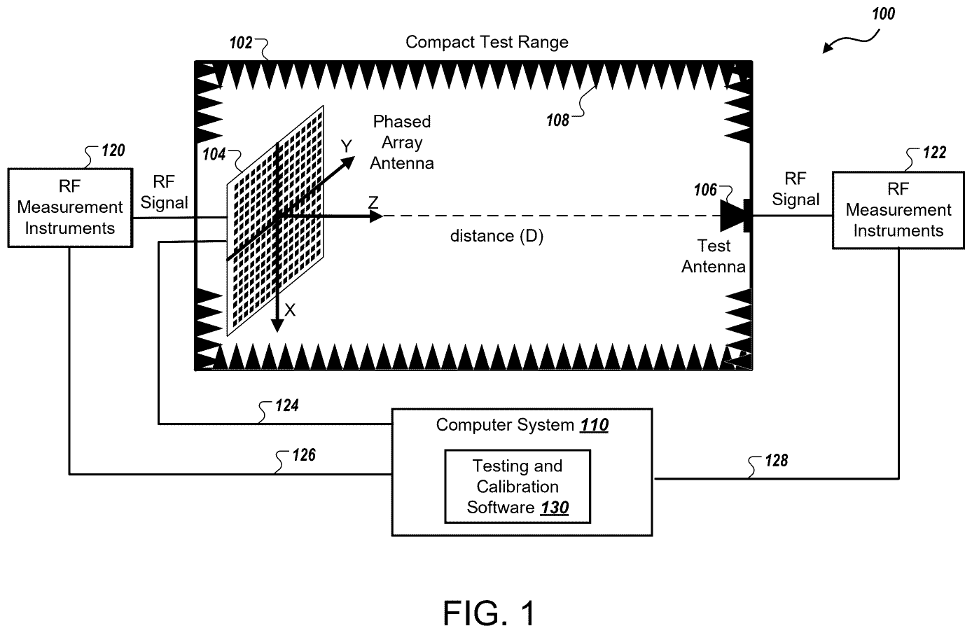

FIG. 1 is a diagram showing an example of a system 100 for phased array antenna beamforming performance testing. By enabling repeatable positioning of the phased array antenna at a set distance from a test antenna less than the far-field distance for the selected transmission frequency (or range of frequencies) to be tested, the system enables ready testing of phased array antennas in factory settings, without requiring large, dedicated testing facilities.

In the exemplary configuration illustrated in FIG. 1, system 100 includes a compact testing range 102 where a phased array antenna 104 can be tested. The compact testing range 102 includes a test antenna 106, such as a horn antenna, that can transmit and receive radiofrequency (RF) signals, and the compact testing range 102 includes reflection-dampening material 108. Reflection-dampening material may include, for example, RF absorbers including magnetic or conductive materials provided as sheets, coatings, or tiles, shaped silicone-based materials, and other suitable materials configured for absorbing or dampening RF radiation.

RF measurement instruments 120, 122 are connected to the phased array antenna 104 and the test antenna 106, respectively, in order to inject signals to be transmitted and to measure signals received. A computer system 110 controls the testing process by coordinating the operation of the phased array antenna 104 and RF measurement instruments 120, 122, including setting beamforming parameters of the phased array antenna 104 and setting power levels and frequencies for transmission. Using the compact testing range 102, the computer system 110 can test the transmission performance of the phased array antenna (e.g., EIRP), reception performance of the phased array antenna (e.g., G/T), and can verify the performance of the phased array antenna 104 for various different beam shapes and/or beam orientations.

As shown in FIG. 1, a compact test range 102 can be used to achieve the speed, accuracy, and size requirements of large-scale manufacturing. In embodiments, the compact test range 102 can be arranged as an enclosure that houses an over-air radio link between the phased array antenna 104 and the test antenna 106. The compact test range 102 can be an RF anechoic enclosure to limit interference from reflecting RF signals within. For example, the compact test range 102 can include reflection-dampening material 108 that keeps the majority of incident RF signals in the tested frequency ranges from being reflected back to the array antenna 104 and the test antenna 106 (e.g., the reflection-dampening material 108, by its material and shape, absorbs, dissipates, or directs away RF signals in the frequency ranges tested).

The RF measurement instruments 120 are configured to send RF signals to and receive RF signals from the phased array antenna 104, as controlled by the computer system 110. The RF measurement instruments 122 are configured to send RF signals to and receive RF signals from the test antenna 106, as controlled by the computer system 110 by signals provided from computer system 110 to instrumentation controlling the test antenna 106. The RF measurement instruments 120, 122 can each include components such as a spectrum analyzer, one or more signal generators, a network analyzer, and so on. In embodiments, computer system 110 may also provide control signals via a connection 124 to instrumentation associated with phased array antenna 104 to control the operation of phased array antenna 104.

The computer system 110 receives measurement results, performs processing to compensate for the differences between near-field and far-field results, and generates calibration data to be stored in the terminal that will use the phased array antenna 104. The computer system 110 communicates with the RF measurement instruments 120, 122 using a digital data connection, such as connections 126 and 128 as provided through a local-area network (LAN). The computer system 110 can specify and a variety of parameters for testing, including the frequency of signals to be transmitted, the power level of signals for transmission, whether the phased array antenna 104 or the test antenna 106 will transmit or receive, which measurements should be made, and so on.

In addition, the computer system 110 can set the beamforming pattern to be applied at the phased array antenna 104, e.g., the beam position to be used for each test. The computer system 110 can be arranged to instruct the RF measurement instruments 120, 122 to generate the signals for the desired antenna element excitation pattern for each test, as well as to specify changes to the antenna element excitations to make during testing. The computer system 110 can include one or more computers, for example, a desktop computer, a laptop computer, a server system, a cloud computing system, and so on.

One of critical parameters in the compact test range design is the distance, D, between the phased array antenna 104 and the test antenna 106. In the compact test range 102, this distance is significantly less than the minimum required far field distance given by

$$\frac{2 {d}^{2}}{λ}$$

where d is the maximum linear dimension of phased array antenna and λ is the wavelength of the signals transmitted. In some implementations, the distance D between the phased array antenna 104 and the test antenna 106 is between about 1/20 and about ½ of the far field distance for the frequency being tested. In some implementations, the distance D between the phased array antenna 104 and the test antenna 106 is between about 1/15 and about ⅕ of the far field distance for the frequency being tested. In some implementations, the distance D is between 1 and 4 meters, or between 2 and 3 meters.

For example, a phased array antenna with a 0.5-meter dimension (e.g., height and width) that transmits or receives signals at 11 GHz has a far field distance of about 18 meters, while the distance in a compact test range 102 can be about 2 to 3 meters. At this distance, the radio waves when arriving at the phased array antenna can no longer be characterized as planar waves. Consequently, in the compact test range 102, the gain and phase characteristics of the signals for each antenna element of the phased array antenna are markedly different from those that would be sent or received in a far field range. This difference significantly affects the calibration and fidelity of RF performance measurements such as EIRP, G/T, and beam shapes. In use for satellite communications, the phased array antenna 104 transmits and receives at a far field distance, and so measures of far-field performance are what are needed for calibration and testing.

The test antenna 106 can be a horn antenna that includes a metal waveguide to direct radio waves in a beam. The test antenna 106 is arranged in the compact test range 102 facing the phased array antenna 104 to be tested. The test antenna 106 and the phased array antenna 104 are aligned in a predetermined alignment, typically with both aligned at or very near their respective boresights. The boresight is the axis of maximum gain, which is typically a central axis of the phased array antenna 104 (e.g., a central axis perpendicular to the array of antenna elements) and a central axis of the test antenna 106.

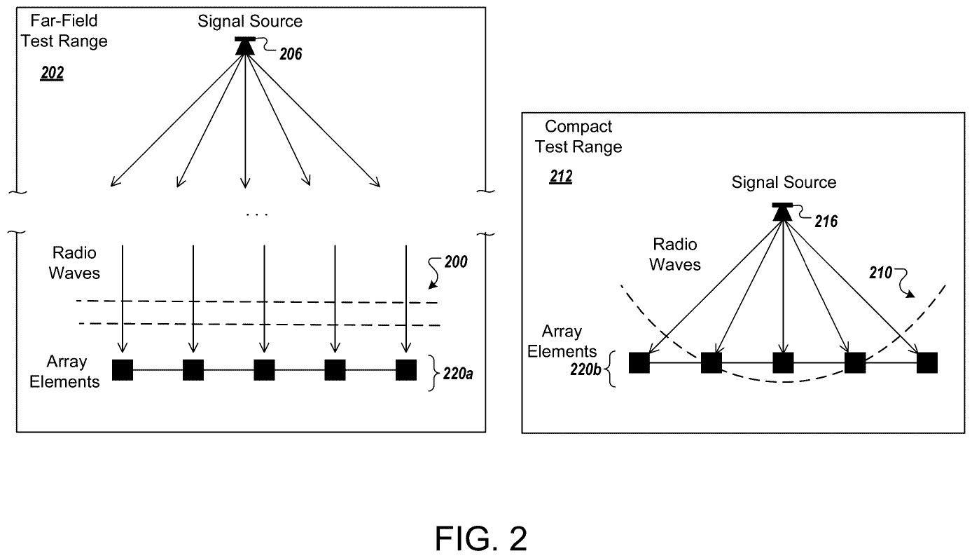

FIG. 2 is a diagram illustrating planar wavefronts 200 and spherical wavefronts 210 incident to antenna arrays 220a, 220b. The example illustrates the fundamental difference in radio wave propagation between a compact test range 212 and a far-field test range 202.

In the far field test range 202, where the distance between the antenna array 220a and a signal source 206 (e.g., a test antenna) is far enough, the radio waves arriving at the antenna array 200a are planar waves with the same amplitude and phase received by each array element, when there is a boresight direction of incoming signals. For the compact test range 212, where the distance is significantly shorter than for far field propagation (e.g., half, a quarter, one eighth, or less), radio waves arriving at the antenna array 220b are spherical waves 210, and each array element receives a different amplitude and phase.

The spherical wavefront 210 in a compact test range 212 has a significant impact on calibration and beamforming performance for several reasons. First, the propagation distances between each antenna element 220b and the signal source 216 are different. This difference results in the different phase changes among antenna elements 220b of the phased array, causing degradation in phase coherence required by beamforming. Second, different propagation distances also lead to the different power for each element due to different path loss. Third, in the compact test range 212, the view angles from the signal source 216 toward the respective antenna elements 220b are also different. In addition, for a test antenna with narrow beam width, the difference in view angles also results in a difference in signal power among the array elements 220b. The result of these factors is often a loss of antenna directivity and changes in the shape of beam patterns, which significantly change the performance measures in the compact test range 212 compared to a far-field condition.

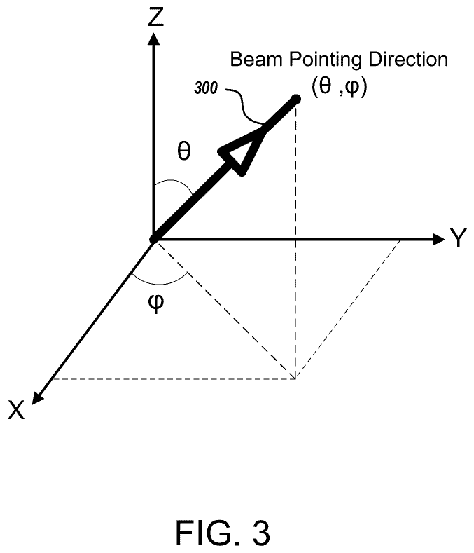

FIG. 3 is a diagram illustrating beam 300 pointing directions of a phased array antenna. The beam pointing direction (or simply “beam direction”) can be defined using spherical coordinates, where the spatial orientation of the beam 300 formed by beamforming is specified with two angles, with angle θ representing the angle between the beam 300 and the Z axis, and angle φ representing the angle with respect to the X axis in the XY plane.

Referring again to FIG. 1, the computer system 110 can store and run testing and calibration software 130 that is configured to (1) control the generation of test signals from one of the RF measurement instruments 120, 122, (2) control the measurement of received signals at the other of the RF measurement instruments 120, 122, and (3) perform the processing of measurement results, including by converting from the near-field measured values to measures of far-field-equivalent performance. The software 130 is programmed to perform calculation of performance measures that take into account the geometry of the compact test range 102 and the nature of radio wave propagation characteristics over the compact test range 102. For example, the directivity and beam shapes of the phased array antenna 104 can be derived from the known characteristics of the geometry of the arrangement of the compact test range 102 (e.g., the position of the array antenna 104 relative to the test antenna 106). The software 130 can calculate performance measures based on the following equations and relationships.

The distance from the individual antenna elements of the phased array antenna 104 to the test antenna 106 varies for each antenna element. The phased array antenna 104 has a set of antenna elements arranged in a plane, in a m by n grid, where m represents the coordinate (or element number) along the X axis, and n represents the coordinate (or element number) along the y axis. The antenna element at coordinate (m,n) is expressed as e(m,n). The distance d(m,n) represents the distance of an individual antenna element e(m,n) to the test antenna 106, which can be obtained based on Euclidean distance according to Equation 1:

$$d ( m , n ) = \sqrt{{X}_{m}^{2} + {Y}_{n}^{2} + {D}^{2}} , \qquad ( Equation 1 )$$

where:
d(m,n) is the distance from antenna element e(m,n) to the test antenna, with m and n representing element index along X-axis and Y-axis respectively,
(Xₘ, Yₙ) is the coordinate of element e(m,n) in the antenna array plane (shown in FIG. 1), and
D is the distance between antenna array and test antenna along the boresight.

The view angle from the test antenna 106 toward the antenna element e(m,n), represented by ∠(m,n), is given by Equation 2:

$$∠ ( m , n ) = {tan}^{- 1} \frac{\sqrt{{X}_{m}^{2} + {Y}_{n}^{2}}}{D} . \qquad ( Equation 2 )$$

The signal phase change over the air propagation from element e(m,n) to the test antenna, represented by Øₐᵢᵣ(m,n), is calculated based on its propagation distance, according to Equation 3:

$${∅}_{air} ( m , n ) = - 2 π \times \frac{d ( m , n )}{λ} , \qquad ( Equation 3 )$$

where λ is the wavelength.

The signal gain over the air including the test antenna for element e(m,n), represented by Aₐᵢᵣ(m,n), is calculated according to Equation 4:

Aₐᵢᵣ(m,n)=Gₕₒᵣₙ(m,n)−Lₐᵢᵣ(m,n) (Equation 4),
where:
   Gₕₒᵣₙ(m,n) is the test antenna gain for element e(m,n) based on its view angle ∠(m,n), and it can be approximated by the following expression, assuming a circular aperture test antenna with boresight gain denoted as Gₕₒᵣₙ, and a 3 dB beamwidth denoted as θ_{3 dB}:

$${G}_{horn} ( m , n ) = {G}_{horn} - {3 [ \frac{∠ ( m , n )}{{θ}_{3 dB}} ]}^{2} ,$$

and
Lₐᵢᵣ(m,n) is the free space path loss from element e(m,n) to the test antenna, and it is given by:

$${L}_{air} ( m , n ) = 20 {log}_{10} \frac{4 π \cdot d ( m , n )}{λ}$$

As a special example, using Equation 4 to express the gain for the element at the center of the phased array antenna 104, a gain represented by A_{ctr}, results in the following:

$${A}_{ctr} = {G}_{horn} - 20 {log}_{10} \frac{4 π \cdot D}{λ}$$

The loss of phased array antenna directivity in the compact range relative to in the far field range, represented by ΔG, can be calculated with Equation 5:

$$Δ G = 20 {log}_{10} \vert \frac{{\sum }_{m = 1}^{M} {\sum }_{n = 1}^{N} A ( m , n ) {e}^{j {∅}_{air} ( m , n )}}{M \times N} \vert , \qquad ( Equation 5 )$$

where:
   M and N represent the number of elements along X-axis and Y-axis respectively, resulting in the total number of elements as M×N,
   Øₐᵢᵣ(m,n) is the phase for element e(m,n) from Equation 3, and
   A(m,n) is the amplitude of element e(m,n) relative the center element of phased array in linear scale, and it is given by:

A(m,n)=10^{[A}^{ₐᵢᵣ}^{(m,n)-A}^{_{ctr}}^{]/20}

For a beam pointing in beam direction of (θ, φ) as illustrated in FIG. 3, the power received from this beam by the test antenna 106 relative to the boresight beam power, represented by ΔP(θ, φ), is given by:

$$Δ P ( θ , φ ) = 20 {log}_{10} \vert \frac{{\sum }_{m = 1}^{M} {\sum }_{n = 1}^{N} {C}_{θ , φ} ( m , n ) \times A ( m , n ) {e}^{j {∅}_{air} ( m , n )}}{{\sum }_{m = 1}^{M} {\sum }_{n = 1}^{N} A ( m , n ) {e}^{j {∅}_{air} ( m , n )}} \vert , \qquad ( Equation 6 )$$

where:
C_{θ,φ}(m,n) is the coefficient for element e(m,n) to form the beam in the direction of (θ, φ) and it is given by:

$${C}_{θ , φ} ( m , n ) = {e}^{- j \frac{2 π}{λ} ( {X}_{m} sin θ cos φ + {Y}_{n} sin θ sin φ )} . \qquad ( Equation 7 )$$

Using the equations and relationships discussed above, the computer system 110 is able to convert near-field performance measures determined using the compact test range 102 to converted measures that represent far-field performance characteristics. The compact test range 102 can be built at low cost to build and operate. The compact test range 102 provides a place where calibration and critical RF performance measurements are conducted. Using corrections derived from the known geometry of the compact test range 102, the computer system 110 mitigates or compensates for the deleterious impact that the compact range (e.g., short distance D) has on calibration and on EIRP and G/T measurement due to the proximity between the phased array antenna 104 and the test antenna 106.

The proposed approach to beamforming pattern verification is also fundamentally different from conventional methods that often require a large space for a far-field test range and often rely on a complicated multi-axis mechanical positioner. Traditionally, beam pattern measurement involves a positioner to mechanically position the antenna array at different azimuth and elevation angles where power measurement is taken at each position to form beam patterns. Measuring with mechanical positioning is costly to implement, is slow to perform measurements, and is often limited to measuring one dimension of a beamforming pattern, and so is not ideal for beamforming testing during mass production.

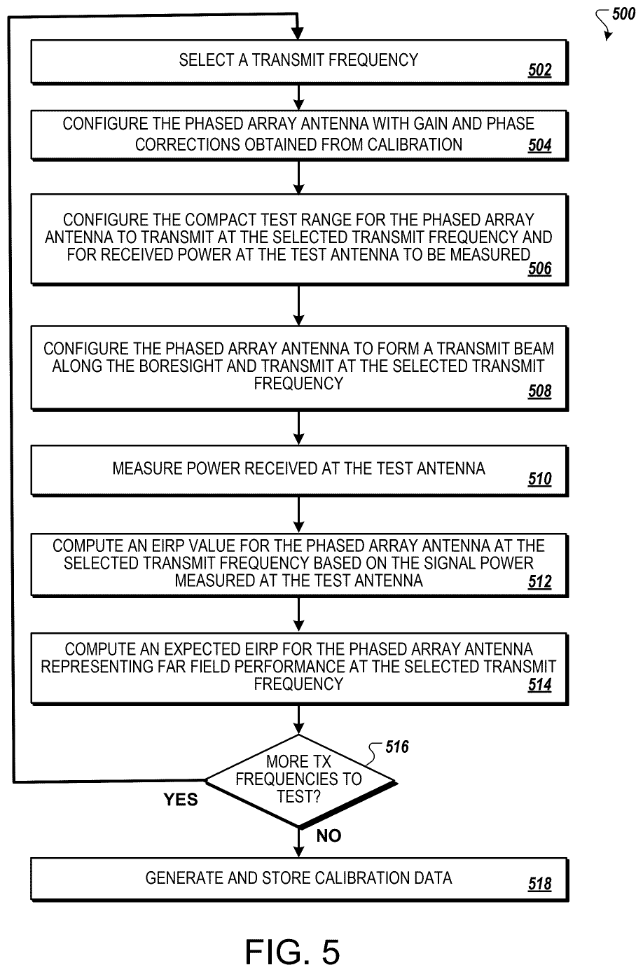

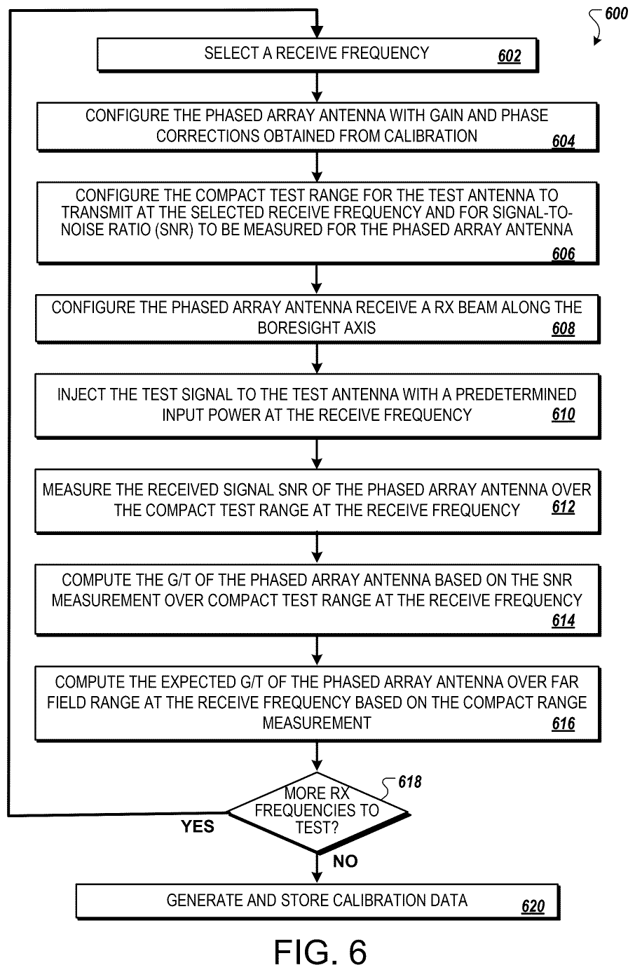

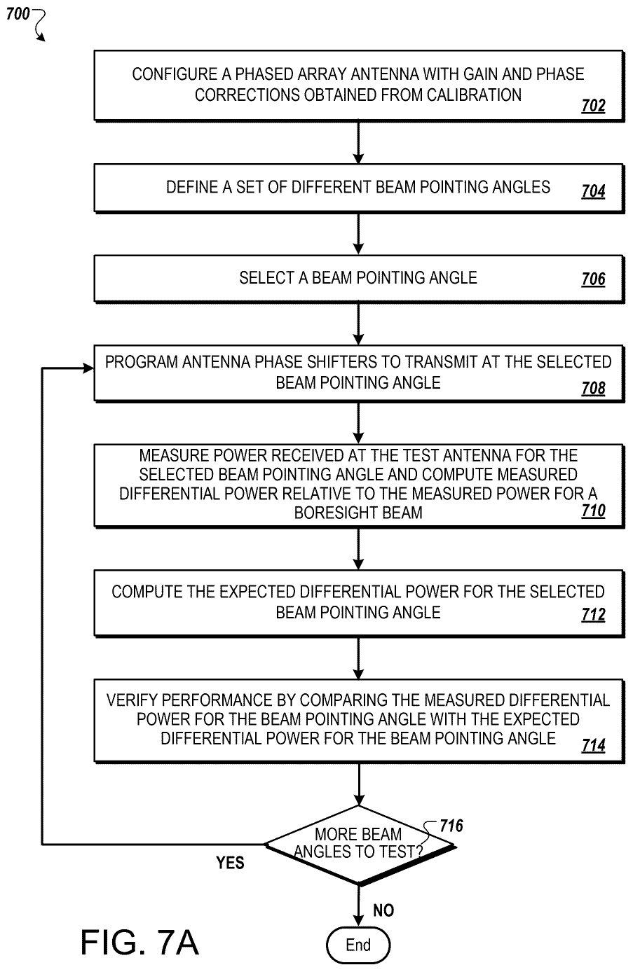

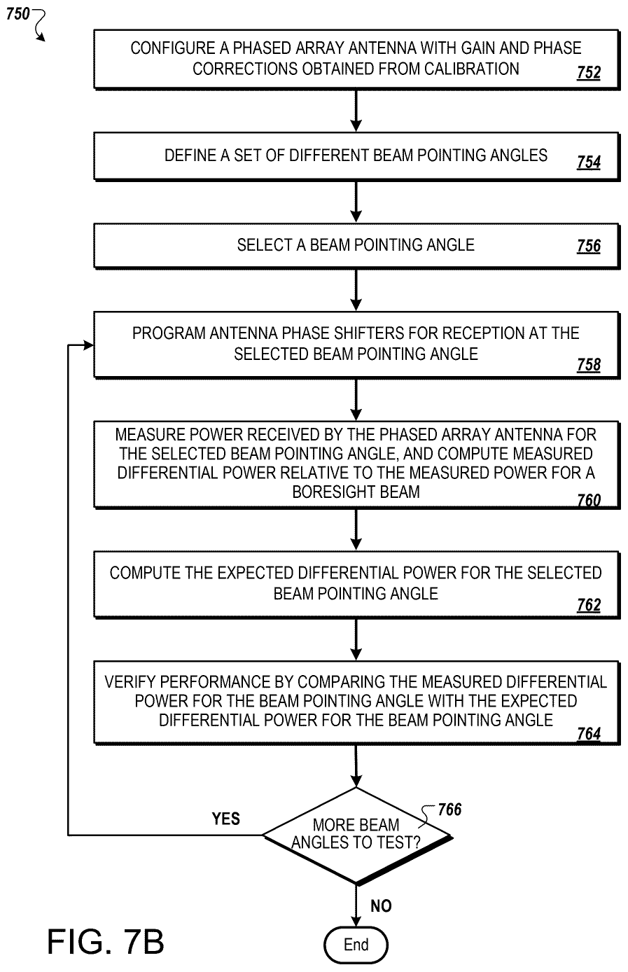

Beamforming tests using the compact test range 102 do not involve a mechanical positioner to change the position of the phased array antenna 104 relative to the test antenna 106. Instead, for beamforming verification, the computer system 110 uses electronic beam steering by adjusting the parameters for the antenna elements of the phased array antenna 104 to move the beam position. For each of the different electronically-steered beam positions, the computer system 110 measures the beam signal power as detected from the fixed test antenna 106, while the test antenna 106 and the phased array antenna 104 remain aligned along their respective boresights. The approach is more flexible, time-efficient, and allows more rigorous test of beamforming over arbitrary scan angles, making it well-suited for factory testing during mass production. The techniques streamline the calibration and tests of key RF parameters including EIRP (see FIG. 5), G/T (see FIG. 6), and beam forming pattern verification (see FIGS. 7A-7B) with enhanced precision.

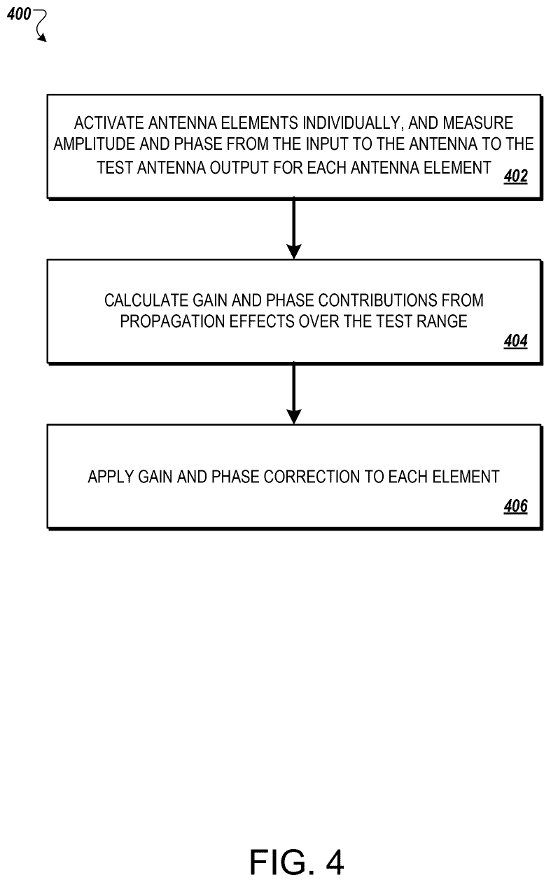

FIG. 4 is a flow diagram illustrating an example of a process 400 for calibrating antenna array elements of the phased array antenna 104. The process 400 can be performed by one or more computers, such as the computer system 110.

Phased array antenna calibration is a process aiming to equalize the gain and phase of the signal paths for all elements over the phased array antenna, such as phased array antenna 104 of FIG. 1. For a phased array antenna, the antenna elements are often arranged on a circuit board and signal paths for the antenna elements tend to have different gain and phase, especially at high frequencies such as the X-band (e.g., 8-12 GHZ), the Ku band (e.g., 12-18 GHZ) and the Ka band (e.g., 27-40 GHZ). The difference in gain and phase among the antenna elements, if not calibrated properly, can have deleterious effects on RF performance due to the non-coherency in signals. Therefore, phased array antenna calibration typically is an important part of optimizing RF performance.

As shown in FIG. 4, process 400 begins with a step 402 to individually activate the antenna elements within the phased array antenna and measure amplitude and phase of the output from each antenna element as received at the test antenna. For instance, in terms of the components shown in FIG. 1, the computer system 110 activates antenna elements and performs measurements for antenna elements of the phased array antenna 104 individually. As an example, the computer system 110 sends instructions or signals to the RF measurement instruments 120 in order to activate each antenna element e(m,n) individually, i.e., one at a time. The computer system 110 instructs the RF measurement instruments 122 to perform separate measurements, for transmissions from each antenna element e(m,n), of the amplitude and phase as detected by the test antenna 106. In other words, the RF measurement instruments 122 measure the received signal at the test antenna 106 corresponding to the input signal injected to the array antenna 104 to the test antenna 106. For each antenna element e(m,n), the measured amplitude is represented by Aₘₑₐₛ(m,n) and the measured phase represented by Øₘₑₐₛ(m,n).

Process 400 proceeds to a step 404 to calculate the gain and phase contributions from propagation effects over the test range, thus taking into consideration the fact that the phased array antenna and the test antenna are positioned less than a far-field distance apart. In terms of the exemplary components of FIG. 1, the computer system 110 calculates gain and phase contributions from propagation effects over the compact test range. It is recognized herein that, because the measurements are performed over compact test range 102, the measurement results include gain and phase contributions from propagation effects over the test range (e.g., a spherical wavefront rather than a planar wavefront) as discussed above. The computer system 110 can calculate the gain Aₐₙₜ(m,n) and phase Øₐₙₜ(m,n) for each element e(m,n) according to:

Aₐₙₜ(m,n)=Aₘₑₐₛ(m,n)−Aₐᵢᵣ(m,n), and

Øₐₙₜ(m,n)=Øₘₑₐₛ(m,n)−Øₐᵢᵣ(m,n)
where:
   Aₐₙₜ(m,n) is the gain for the element e(m,n) signal over the phased array antenna.
   Øₐₙₜ(m,n) is the phase for the element e(m,n) signal over the phased array antenna,
   Øₐᵢᵣ(m,n) is the over-air phase for element e(m,n) from Equation 3 above, and
   Aₐᵢᵣ(m,n) is over-air gain for element e(m,n) from Equation 4 above.

Referring back to FIG. 4, process 400 then proceeds to a step 406 to apply gain and phase correction to each array element in the phased array antenna, according to the calculations above. For example, the computer system 110 applies gain and phase correction to each antenna element of the phased array antenna 104 being tested. Once the gain and phase for each antenna element are obtained, the computer system 110 can perform phased array antenna calibration across all antenna elements by applying following gain and phase correction to each element. The gain correction, determination of a calibrated gain A_{cal}, can be determined by:

$${A}_{cal} ( m , n ) = - [ {A}_{ant} ( m , n ) - \frac{{\sum }_{m = 1}^{M} {\sum }_{n = 1}^{N} {A}_{ant} ( m , n )}{M \times N} ] ,$$

where A_{cal}(m,n) is the gain correction applied to element e(m,n). The phase correction, or calculation of a calibrated phase Ø_{cal}, can be determined by:

Ø_{cal}(m,n)=−Øₐₙₜ(m,n),

where Ø_{cal}(m,n) is the phase correction applied to element e(m,n).

Once the gain and phase corrections are determined, the computer system 110 stores the corrected values for the phased array antenna 104. The gain and phase corrections are retained and are applied during further testing and calibration processes, such as those discussed below for FIGS. 5, 6, and 7A-7B. In addition, the corrections can be saved for use in a communication device that includes the phased array antenna 104, such as a VSAT. In some implementations, the antenna elements of the phased array antenna 104 can be arranged on a circuit board, and the circuit board can include a non-volatile memory that is used to store calibration parameters for the phased array antenna 104. The calibration data can be additionally or alternatively stored in other components of a communication device.

FIG. 5 is a flow diagram illustrating an example of a process 500 for calculating the EIRP of a phased array antenna using a compact test range and for storing associated calibration data of a communication device. The process 500 can be performed by one or more computers, such as the computer system 110.

For measuring and calculating EIRP, the computer system 110 configures the RF measurement instruments 120, 122 for the phased array antenna 104 to act as a transmitter and for the test antenna 106 to act as a receiver. The computer system 110 can be configured to measure EIRP at each of multiple frequencies, since EIRP typically varies depending on the frequency transmitted.

In an exemplary process, a transmit frequency for testing is selected in a step 502, which may be performed, for instance, at the computer system 110. For example, the computer system 110 selects one of a predetermined set of transmit frequencies for which the phased array antenna 104 has not yet been tested.

Process 500 then proceeds to a step 504 to configure the phased array antenna with the gain and phase corrections, such as obtained using process 400 illustrated in FIG. 4. In terms of the exemplary embodiment shown in FIG. 1, the computer system 110 configures the phased array antenna 104 with the gain and phase corrections obtained from the calibration process of FIG. 4. The computer system 110 can apply the corrections by passing information to the RF measurement instruments 120, which can have functionality to apply corrections when generating signals to excite the antenna elements of the array antenna 104.

Process 500 proceeds to a step 506, in which the phased array antenna is caused to transmit a signal at the selected transmit frequency, and the resulting signal is measured at the test antenna. For instance, step 506 may be implemented by computer system 110, which configures the phased array antenna 104 within the compact test range 102 to transmit at the selected frequency, and for power received at the test antenna 106 to be measured. For example, the computer system 110 instructs the RF measurement instruments 120 to generate a test signal at the selected frequency to be injected to the phased array antenna 104. The computer system 110 instructs the RF measurement instruments 122 to measure power received at the test antenna 106 (e.g., the received power output from the test antenna 106 to the RF measurement instruments 122).

Process 500 proceeds to a step 508, in which the phased array antenna is caused to form a transmit beam along the boresight at the selected transmit frequency. In terms of the exemplary embodiment illustrated in FIG. 1, computer system 110 may configure the phased array antenna 104 to form a transmit (TX) beam along the boresight to transmit the test signal at the selected transmit frequency (508). For example, the computer system 110 can instruct the RF measurement instruments to generate the test input signal at the selected transmission frequency and to excite the antenna elements of the phased array antenna 104 with the pattern that corresponds to a beam along the boresight of the phased array antenna 104.

The resulting boresight transmission beam is then received and measured at the test antenna in a step 510. For instance, the computer system 110 causes the RF measurement instruments 122 to measure the signal power that is received and output by the test antenna 106 in response to transmission of the test signal by the phased array antenna 104.

Then, in a step 512, an EIRP value for the array antenna at the selected transmit frequency is calculated. For instance, computer system 110 may compute the EIRP of the phased array antenna 104 based on the power measurement over the compact test range 102 at the selected transmit frequency. The computer system 110 can compute the EIRP according to Equation 8:

EIRP_{CR}=P_{TX}+PL_{TX}−G_{hornTX} (Equation 8),
where:
   EIRP_{CR} is the EIRP measured over the compact test range 102,
   Pᵣₓ is the measured power at the test antenna output for the boresight beam,
   PL_{TX} is the free-space path loss over the compact test range 102 at the transmit frequency, and
   G_{hornTX} is the gain of the test antenna 106 at the transmit frequency.

In a step 514, an expected EIRP for the phased array antenna is calculated, representing far-field performance at the selected transmit frequency for the phased array antenna. In an example, the computer system 110 computes the expected EIRP of the phased array antenna 104 at the transmit frequency over a far-field range based on the compact range measurement. For instance, the computer system 110 applies a correction to the measured EIRP of step 512 to compensate for effects of the compact test range 102. This results in an estimated or expected far-field EIRP value that can be equivalent or at least closely approximates the actual far-field EIRP for the phased array antenna 104 at the selected transmit frequency. The computer system 110 can calculate the expected far-field EIRP according to Equation 9:

EIRP_{FR}=EIRP_{CR}+ΔG (Equation 9),
where:
   EIRP_{FR} is the EIRP of the phased array antenna over a far-field range (with “FR” representing far field),
   EIRP_{CR} is the EIRP of the phased array antenna measured over the compact test range given by Equation 8 (with “CR” representing compact range), and
   ΔG is a correction factor, given by Equation 5, that is based on the phased array directivity difference between the compact range and far field at the selected transmit frequency.

Process 500 proceeds to a decision 516 to determine whether the measurements should be repeated for additional transmit frequencies. That is, after computing and storing the expected far-field EIRP for the selected transmit frequency, the computer system 110 determines if there are additional transmit frequencies to be tested. For example, the computer system 110 can be configured to measure the EIRP for each of a set of multiple predetermined transmit frequencies for each phased array antenna 104. The computer system 110 tracks which transmit frequencies have been tested, and which have not. If the computer system 110 determined that there is another transmit frequency in the set that has not been tested, the computer system 110 repeats testing by returning to step 502 and selecting another transmit frequency from the set. The computer system 110 continues with this process until each of the transmit frequencies in the set have been tested and corresponding EIRP values determined.

In a step 518, process 500 generates and stores calibration data for the phased array antenna so tested, based on the measurements described above. For instance, computer system 110 can generate and store calibration data for the phased array antenna 104.

As context, in many satellite terminals and other communication devices with phased array antennas, the far-field EIRP values for different transmit frequencies are stored in the device as calibration values. During operation of the satellite terminal, the stored EIRP values are retrieved and used to determine the correct amount of power to supply to the corresponding phased array antenna. For the phased array antenna 104, the computer system 110 can provide the expected far-field EIRP values (e.g., as calculated by applying corrections to the measured compact-range EIRP values) for storage in a non-volatile memory associated with the phased array antenna. For example, the computer system 110 can store the expected far-field EIRP values in a list, table, or other data structure, where the satellite terminal is configured to access the stored values and use them to provide calibrated power levels for making transmissions using the phased array antenna 104.

FIG. 6 is a flow diagram illustrating an example of a process 600 for calculating G/T for a phased array antenna to be implemented, for example, using a compact test range of FIG. 1, and storing calibration data of a communication device. The process 600 can be performed by one or more computers, such as the computer system 110.

As an example, for measuring and calculating G/T, the computer system 110 configures the RF measurement instruments 120, 122 for the phased array antenna 104 to act as a receiver and for the test antenna 106 to act as a transmitter. The computer system 110 can be configured to measure G/T at each of multiple frequencies, because G/T typically varies depending on the frequency received by the phased array antenna 104.

In an exemplary process, a process 600 begins with a step 602 to select a receive (RX) frequency to be tested. For example, the computer system 110 selects one of a predetermined set of receive frequencies with which the phased array antenna 104 has not yet been tested.

In a step 604, the phased array antenna is configured with the gain and phase corrections as obtained using a calibration process, such as illustrated in FIG. 4. For example, computer system 110 may configure the array antenna 104 with the gain and phase corrections obtained from the calibration process of FIG. 4. In embodiments, computer system 110 can apply the corrections by passing information to the RF measurement instruments 120, which can have functionality to apply corrections when generating signals to excite the antenna elements of the array antenna 104.

Process 600 proceeds to a step 606 to cause the test antenna to transmit at the selected receive frequency such that a signal-to-noise ratio (SNR) may be measured at the phased array antenna. In embodiments, the computer system 110 configures the compact test range 102 for the test antenna 106 to transmit at the selected receive frequency and for signal-to-noise ratio (SNR) to be measured for the phased array antenna 104. For example, the computer system 110 instructs the RF measurement instruments 122 to generate a test signal at the selected receive frequency (e.g., a receive frequency of the phased array antenna 104) to be injected to the test antenna 106 for transmission. The computer system 110 may instruct the RF measurement instruments 120 to measure signal-to-noise ratio (SNR) for output of the phased array antenna 104 generated in response to receiving the signals from the phased array antenna.

In a step 608, the phased array antenna receives the receive beam from the test antenna 106 along the boresight. For instance, the computer system 110 may configure the phased array antenna 104 to form a receive (RX) beam along its boresight axis (608). For example, the computer system 110 provides instructions to the RF measurement instruments 120 to apply beamforming parameters for the antenna elements of the phased array antenna 104 to receive the receive beam along the boresight.

Process 600 proceeds to a step 610 to cause the test antenna to transmit a test signal with predetermined characteristics at the receive frequency. In an example, computer system 110 causes the RF measurement instruments 122 to inject the test signal to the test antenna 106 with a predetermined level of input power of P_{RX} at the receive frequency so as to produce the desired test signal at the receive frequency.

Then, in a step 612, the test signal at the receive frequency is received at the phased array antenna and the SNR of the signal so received is calculated. For example, computer system 110 causes the RF measurement instruments 120 to measure the received signal SNR of the phased array antenna 104 (e.g., at the output of the phased antenna array 104 from receiving the transmitted signal at the receive frequency). This measurement thus provides a SNR value for reception performance for phased array antenna 104 in the compact test range 102 at the receive frequency.

Process 600 proceeds to a step 614 to calculate the G/T of the phased array antenna in consideration of the SNR measurement at the receive frequency. In terms of the exemplary embodiment of FIG. 1, computer system 110 computes the G/T of the phased array antenna 104 for the compact range based on the SNR measurement over the compact test range at the receive frequency. For example, the computer system 110 can compute the G/T over the compact test range 102 at the receive frequency according to Equation 10:

GT_{CR}=SNRₘₑₐₛ−[P_{RX}+G_{hornRx}−PL_{RX}−10×log₁₀B−K] (Equation 10),
where:
   GT_{CR} is the G/T measured over the compact test range 102,
   SNRₘₑₐₛ is the SNR measured over the compact test range 102 for the boresight beam,
   P_{RX} is the test signal power at the input to the test antenna 106,
   G_{hornRx} is the gain of the test antenna 106 at the receive frequency,
   PL_{RX} is the free-space path loss at the receive frequency over the compact test range 102,
   B is noise signal bandwidth used for SNR measurement,
   K is Boltzmann's constant (i.e., −228.6 dBW/HzK).

In a step 616, the expected phased array antenna over the far-field range at the receive frequency is calculated, based on the SNR and G/T calculations obtained thus far using the configuration with the phased array antenna and the test antenna located less than far-field distance apart. For example, computer system 110 may compute the expected G/T of the phased array antenna 104 over a far field range based on the compact range measurement. This value can represent an calculated value that is indicative of or approximates the far-field G/T value of the phased array antenna 104. The computer system 110 can calculate the expected G/T value as:

GT_{FR}=GT_{CR}+ΔG
where:
   GT_{FR} is the antenna array G/T over a far field range,
   GT_{CR} is the antenna array G/T measured over the compact test range 102 given by Equation 10, and
   ΔG is the correction factor based on the phased array directivity difference between compact range and far field at the receive frequency and it is given by Equation 5.

After computing and storing the expected far-field G/T for the selected receive frequency, a determination 618 may be made whether the testing should be repeated for additional receive frequencies. In embodiments, computer system 110 determines if there are additional receive frequencies to be tested. For example, the computer system 110 can be configured to measure the G/T for each of a set of multiple predetermined receive frequencies for each phased array antenna 104 unit tested. The computer system 110 tracks which receive frequencies have been tested, and which have not for the current unit. If the computer system 110 determined that there is another receive frequency in the set that has not been tested, the computer system 110 repeats testing by returning to step 602 and selecting another receive frequency from the set. The computer system 110 continues with this process until each of the receive frequencies in the set have been tested and corresponding G/T values determined.

The resulting expected G/T values are incorporated into calibration data and stored, in a step 620. In embodiments, computer system 110 may generate and store calibration data for the phased array antenna 104 based on the expected far-field G/T values. For example, the computer system 110 can store the expected far-field G/T values, or other operating parameter values based on them, in storage in a non-volatile memory associated with the phased array antenna. For example, the computer system 110 can store the expected far-field G/T values for different frequencies (or other parameter values based on them) in a list, table, or other data structure, where the satellite terminal is configured to access the stored values and use them to adjust reception using the phased array antenna 104.

FIG. 7A is a flow diagram illustrating an example of a process 700 for beamforming pattern verification for signals transmitted by the phased array antenna using the compact test range 102. The process 700 can be performed by one or more computers, such as the computer system 110.

One of the important performance characteristics of a phased array antenna 104 is how accurately it can point and shape beams. Small changes in materials used or the positions of antenna elements can result in deviation of beam shape and beam orientation compared to the theoretical or expected beam shape, resulting in reduced gain or error in beam direction or other performance problems. To verify beam shape and beamforming performance generally, the theoretical or desired antenna characteristics for different beam orientations can be calculated and compared with the actual measured performance characteristics.

For example, the computer system 110 can calculate a measure for a phased array antenna 104 based on measured power for a beam at a particular orientation (that is different from the boresight) relative to the measured power for a beam at boresight (e.g., by determining a difference, a ratio, or other calculation based on the two measurements). The computer system 110 can then compare this measure to a corresponding reference measure that is based on the calculated or expected power at the particular orientation and the calculated expected power at the boresight. Comparing the two measures can indicate whether the beam performance at the particular beam orientation meets performance standards. For example, the computer system 110 can determine, based on the measures, whether the phased array antenna 104 meets a threshold level of performance needed for quality assurance in a factory setting.

The computer system 110 can control the RF measurement instruments 120, 122 to test beamforming performance at each of various different beam orientations, without physically moving the phased array antenna 104 or the test antenna 106, using electronic beam steering of the phased array antenna 104. The computer system 110 can also optionally test performance for signals of different frequencies or with other changes in conditions.

For transmission beamforming pattern verification, the computer system 110 configures the compact test range 102 so that a test signal from the RF measurement instruments 120 is injected to the phased array antenna 104 and the power received over the air by the test antenna 106 is measured by the RF measurement instruments 122.

Returning to FIG. 7A, process 700 includes a step 702 to configure a phased array antenna with a starting set of gain and phase corrections obtained from previous calibration. For example, the computer system 110 may configure the phased array antenna 104 with gain and phase corrections obtained from a calibration process, such as that discussed with respect to FIG. 4.

Process 700 proceeds to a step 704 to define a range of beam pointing angles to be tested. For instance, the computer system 110 may be used to define a set of different beam pointing angles (θ,φ) to be tested. The beam pointing angles can be strategically selected to optimize the test coverage on pointing directions, including for the main lobe and side lobes of beams. For example, some beam pointing angles may test main lobe performance and other beam pointing angles may test side lobe performance for one or different side lobes. In some implementations, the set of angles represents different angles in a plane through the boresight.

A specific beam pointing angle, from the set defined for testing, is selected in a step 706. For instance, the computer system 110 may be used to select a beam pointing angle (θ,φ) from among the set.

The phase array antenna is then caused to transmit at the selected beam pointing angle in a step 708. For example, the computer system 110 may be used to programs phase shifters of the phased array antenna 104 for transmission at the selected angle (θ,φ), such as by programing the phase shifters of the phased array antenna based on Equation 7.

In a step 710, the transmission from the phased array antenna at the selected beam pointing angle is then received and measured at the test antenna. In terms of the exemplary embodiment shown in FIG. 1, computer system 110 may be used to cause the RF measurement instruments 122 to measure power received at the test antenna 106 for the selected beam pointing angle, while the phased array antenna 104 transmits at the selected beam pointing angle. The computer system 110 may also be used to compute a measured differential power relative to the measured power for a boresight beam of the same phased array antenna 104. For example, the computer system can determine the measured power received for the selected beam pointing angle, P′(θ, φ), and compute its power relative to the measured power for boresight beam represented by P′(0,0):

ΔP′(θ,φ)=P′(θ,φ)−P′(0,0).

In a step 712, an expected differential power may be computed, based on the measurement made in step 710. For example, computer system 110 may be used to compute an expected differential power ΔP(θ,φ) based on the Equation 6 for the selected beam pointing angle.

In a step 714, a comparison of the measured differential power and the expected differential power is made to verify the performance of the phased array antenna at the selected beam pointing angle. For instance computer system 110 may be used to compare the measured differential power ΔP′(θ,φ) obtained from step 710 and the expected power ΔP (θ,φ) obtained from step 712 to verify the consistency of the beamforming pattern for transmission at the selected beam angle.

A determination 716 is made to determine whether additional beam angles remain to be tested. For example, computer system 110 may be used to determine whether there are remaining beam angles to be tested out of the set of different beam pointing angles defined in step 704. If there are additional beam angles to be tested, the computer system 110 returns to step 706. After each of the different beam angles have been tested, the computer system 110 can compare the results to determine a classification for the phased antenna array for transmission beamforming (e.g., pass, fail, etc.).

FIG. 7B is a flow diagram illustrating an example of a process 750 for beamforming pattern verification for signals received by the phased array antenna, such as using the compact test range 102. In certain embodiments, process 750 can be performed by one or more computers, such as the computer system 110. The process 750 can include operations similar to those of the process 700 in FIG. 7A, but with the compact test range 102 being used to test reception performance of the phased array antenna 104 rather than transmission performance.

The computer system 110 can control the RF measurement instruments 120, 122 to test beamforming performance at each of various different beam orientations, without physically moving the phased array antenna 104 or the test antenna 106, using electronic beam steering of the phased array antenna 104. The computer system 110 can also optionally test performance for signals of different frequencies or with other changes in conditions.

For reception beamforming pattern verification, the computer system 110 configures the compact test range 102 so that a test signal from the measurement instruments 122 is injected to the test antenna 106 and the power received over the air by the phased array antenna 104 is measured by the RF measurement instruments 120.

In a step 752, the phased array antenna is configured with the gain and phase corrections as earlier obtained in a calibration process. For example, computer system 110 may be used to configure the phased array antenna 104 with gain and phase corrections obtained from the calibration process discussed with respect to FIG. 4.

A set of beam pointing angles to be tested is defined in a step 754. For instance, computer system 110 defines a set of different beam pointing angles (θ,φ) to be tested, where the beam pointing angles may be strategically selected to optimize the test coverage on pointing directions, including for the main lobe and side lobes of beams. For example, some beam pointing angles may test main lobe performance and other beam pointing angles may test side lobe performance for one or different side lobes. In some implementations, the set of angles represents different angles in a plane through the boresight.

In a step 756, a specific beam pointing angle to be tested is selected. For example, the computer system 110 selects a beam pointing angle (θ,φ) from among the set.

The phase shifters of the phased array antenna are adjusted for receiving signals at the selected beam pointing angle in a step 758. For example, the computer system 110 may be used to program phase shifters of the phased array antenna 104 for reception at the selected angle (θ,φ). In embodiments, the computer system can control antenna beam pointing by programing its phase shifters based on Equation 7.

The test antenna is then caused to provide signal to the phased array antenna by over-air transmission, and the phased array antenna measures the power received at the selected beam pointing angle. The results of the measurement may be used to compute a measured differential power relative to the measured power of a boresight beam, in a step 760. In embodiments, computer system 110 causes the RF measurement instruments 120,122 to measure power received at the phased array antenna 104 for the selected beam pointing angle, while the test antenna 106 transmits a signal. The computer system 110 also computes a measured differential power relative to the measured power for a boresight beam of the same phased array antenna 104. For example, the computer system can determine the measured power received for the selected beam pointing angle, P′(θ,φ), and compute its power relative to the measured power for boresight beam represented by P′(0,0):

ΔP′(θ,φ)=P′(θ,φ)−P′(0,0)

An measured differential power for the selected beam pointing angle is calculated in a step 762, an expected differential power for the selected beam pointing angle is also calculated in a step 764, then a comparison between the measured and expected differential power for the selected beam pointing angle is made to verify performance of the phased array antenna. For instance, computer system 110 computes an expected differential power ΔP(θ,φ) based on the Equation 6 for the selected beam pointing angle, then compares the measured differential power ΔP′(θ,φ) obtained from step 760 and the expected power ΔP(θ,φ) obtained from step 762 to verify the consistency of the beamforming pattern for transmission at the selected beam angle.

Finally, a determination 766 is made whether additional beam angles remain for testing, based on the set of different beam pointing angles defined in step 754. If additional beam pointing angles remain to be tested, the computer system 110 returns to processing at step 706. After each of the different beam angles have been tested, the computer system 110 can compare the results to determine a classification for the phased antenna array for reception beamforming (e.g., pass, fail, etc.).

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method of calibrating a phased array antenna of a communication device, the phased array antenna including a plurality of antenna elements, the method comprising:
providing a test antenna and a computer system, the computer system being configured for controlling operations of the phased array antenna and the test antenna, and
positioning the phased array antenna with respect to the test antenna such that a distance between the phased array antenna and the test antenna is less than a far-field distance for a selected transmission frequency,
wherein the computer system including one or more processors and memory storing computer-executable instructions that, when executed by the one or more processors, perform operations including
causing a first one of the plurality of antenna elements of the phased array antenna to make a first transmission on an over-air radio link between the phased array antenna and the test antenna;
at the test antenna, measuring a first radiofrequency (RF) signal resulting from the first transmission,
generating a first performance measure for the first one of the plurality of antenna elements of the phased array antenna based on the first RF signal so measured at the test antenna;
calculating an adjusted performance measure including a first correction to approximate performance of the first one of the plurality of antenna elements of the phased array antenna in a far-field; and
storing the first correction as a portion of calibration data for the first one of the plurality of antenna elements of the phased array antenna.

2. The method of claim 1, wherein the operations further includes
causing the test antenna to make a second transmission on the over-air radio link to the first one of the plurality of antenna elements of the phased array antenna;
at the first one of the plurality of antenna elements of the phased array antenna measuring a second RF signal resulting from the second transmission,
generating a second performance measure for the first one of the plurality of antenna elements of the phased array antenna based on the second RF signal so measured at the first one of the plurality of antenna elements of the phased array antenna;
recalculating the adjusted performance measure additionally including a second correction to approximate performance of the first one of the plurality of antenna elements of the phased array antenna in the far-field; and
storing the second correction as another portion of calibration data for the first one of the plurality of antenna elements of the phased array antenna.

3. The method of claim 2, further comprising repeating the operations for a second one of the plurality of antenna elements of the phased array antenna.

4. The method of claim 3, further comprising repeating the operations for all of the plurality of antenna elements of the phased array antenna to obtain the calibration data for the phased array antenna as a whole.

5. The method of claim 4, further comprising providing the calibration data to the communication system to enable adjustment of signals provided to the phased array antenna based on the calibration data.

6. The method of claim 4, wherein:
the performance measure includes at least one of equivalent isotropic radiated power (EIRP) of the phased array antenna and a gain-to-noise-temperature (G/T) of the phased array antenna; and
the adjusted performance measure is based on the distance between the phased array antenna and the test antenna.

7. The method of claim 4, the operations further including
measuring a total RF power received at the test antenna as a result of transmission from the phased array antenna;
calculating a measure of equivalent isotropic radiated power (EIRP) for the phased array antenna based on a total measured power received at the test antenna; and
calculating an adjusted EIRP indicative of far-field EIRP for the phased array antenna.

8. The method of claim 4, the operations further including
measuring a signal-to-noise ratio (SNR) for the phased array antenna;
calculating a measure of gain-to-noise-temperature (G/T) based on the measured SNR for the phased array antenna; and
calculating an adjusted G/T indicative of far-field G/T for the phased array antenna.

9. The method of claim 1, wherein the distance is from ½ of the far field distance to 1/20 of the far field distance.

10. The method of claim 1, wherein the distance is from ⅕ of the far field distance to 1/15 of the far field distance.

11. The method of claim 4, further comprising repeating the operations for multiple frequencies over a selected frequency range.

12. The method of claim 4, wherein the operations further includes evaluating beamforming performance of the phased array antenna for transmission, evaluating including:
determining a set of beam positions to test; and
for each selected beam position in the set of beam positions:
causing the plurality of antenna elements of the phased array antenna to transmit at the selected beam position;
measuring a power level for signals received at the test antenna as a result of the plurality of antenna elements of the phased array antenna transmitting at the selected beam position;
calculating a differential power level based on the power level so measured and a known value of measured power at the test antenna for transmission from a boresight beam;
calculating an adjusted differential power level by applying an adjustment based on the distance between the phased array antenna and the test antenna; and
comparing the differential power level for the selected beam position with the adjusted differential power level for the selected beam position.

13. The method of claim 4, wherein the operations further includes evaluating beamforming performance of the phased array antenna for reception, evaluating including:
determining a set of beam positions to test; and
for each selected beam position in the set of beam positions:
configuring antenna elements of the phased array antenna for reception at the selected beam position;
causing the test antenna to provide a test transmission toward the phased array antenna;
calculating a differential power level based on the power level so measured and a known value of measured power received at the phased array antenna from a boresight beam;
calculating an adjusted differential power level by applying an adjustment based on the distance between the phased array antenna and the test antenna; and
comparing the differential power level for the beam position with the adjusted differential power for the beam position.

14. A system for calibrating a phased array antenna, the system comprising:
a test antenna;
a first radiofrequency (RF) measurement instrument configured to deliver signals for the test antenna to transmit and measure characteristics of signals received by the test antenna;
a second RF measurement instrument configured to deliver signals for the phased array antenna to transmit and measure characteristics of signals received by the phased array antenna; and
a computer system including one or more processors and memory storing computer-executable instructions that, when executed by the one or more processors, perform operations including
determining performance characteristics of the phased array antenna based on interactions between the test antenna and the phased array antenna on an over-air radio link at a selected frequency while the phased array antenna is positioned with respect to the test antenna such that a distance between the phased array antenna and the test antenna is less than a far-field distance for the selected transmission frequency,
calculating a performance measure indicative of far field performance of the phased array antenna based on measurements of interactions between the test antenna and the phased array antenna on the over-air radio link.

15. The system of claim 14, further comprising an enclosure for supporting the test antenna and the phased array antenna therein,
wherein an internal surface of the enclosure comprises material configured to dampen RF waves incident thereon.

16. The system of claim 14, wherein the operations further include:
controlling the second radiofrequency measurement instrument to cause the phased array antenna to make a transmission to the test antenna on the over-air radio link;
controlling the first radiofrequency measurement instrument to measure power received at the test antenna as a result of the transmission from the phased array antenna;
calculating a measure of equivalent isotropic radiated power (EIRP) for the phased array antenna based on the measured power received at the test antenna;
generating an adjusted EIRP that is indicative of far-field EIRP for the phased array antenna;
incorporating the adjusted EIRP into the performance measure; and
generating calibration data based on the performance measure.

17. The system of claim 14, wherein the performance measure includes at least one of equivalent isotropic radiated power (EIRP) and a gain-to-noise-temperature (G/T) of the phased array antenna.

18. The system of claim 14, wherein the operations further include:
controlling the first radiofrequency measurement instrument to cause the test antenna to make a transmission to the phased array antenna on the over-air radio link;
controlling the second radiofrequency measurement instruments to measure a signal-to-noise ratio (SNR) for the phased array antenna as a result of the transmission from the test antenna;
calculating a measure of gain-to-noise-temperature (G/T) based on the measured SNR for the phased array antenna;
generating
an adjusted G/T that is indicative of far-field G/T for the phased array antenna; and
incorporating the adjusted G/T into the performance measure.

19. The system of claim 14, wherein the computer system is configured to test performance of the phased array antenna for multiple frequencies over a selected frequency range.

20. A non-transitory computer-readable media storing computer-executable instructions that, when executed by one or more processors of a computing system, to cause the one or more processors to perform operations comprising:
causing at least one of a phased array antenna and a test antenna to make a transmission on an over-air radio link between the phased array antenna and the test antenna while the phased array antenna and the test antenna are located within a compact testing range such that the transmission is measurable at at least one of the phased array antenna and the test antenna;
generating a performance measure for the phased array antenna based on the RF signal so measured at at least one of the phased array antenna and the test antenna;
calculating an adjusted performance measure including a correction to approximate performance of the phased array antenna in a far-field; and
storing the correction as calibration data for the phased array antenna,
wherein the phased array antenna is located at a distance to the test antenna that is less than a far-field distance for a frequency of the transmission.
